(19) United States
(12) Patent Application Publication
(10) Pub. No.: US 2023/0219684 A1
(43) Pub. Date: Jul. 13, 2023

(54) ENHANCED CONTROLLED AERODYNAMICS AND HYDRODYNAMICS OVER SURFACES PATTERNED WITH HYDROPHILIC AND HYDROPHOBIC COATINGS

(71) Applicant: William H. Niedermeyer, West Jordan, UT (US)

(72) Inventor: William H. Niedermeyer, West Jordan, UT (US)

(21) Appl. No.: 18/092,312

(22) Filed: Dec. 31, 2022

Related U.S. Application Data
(60) Provisional application No. 63/295,792, filed on Dec. 31, 2021.

(51) Int. Cl. B64C 21/10; B23K 26/364; B23K 26/06

(52) U.S. Cl. CPC B64C 21/10; B23K 26/364; B23K 26/0661; B23K 2103/50

(57) ABSTRACT

The present invention is directed to a combination of hydrophilic and hydrophobic features disposed on a surface to control flow over the surface.

Pursuant to 35 U.S.C. 119(e), this application is a continuation of and claims the benefits and priorities of prior-filed and pending U.S. Provisional Patent Application Ser. No. 63/295,792 filed Dec. 31, 2021.

### BACKGROUND OF THE INVENTION

### 1. Field of the Invention

The disclosed technology is an invention which enhances the control of aerodynamics and hydrodynamics over surfaces. In particular, it is directed to patterned combinations of hydrophilic and hydrophobic coatings disposed on surfaces.

### 2. Background and Related Art

Aerodynamics and hydrodynamics over surfaces have been observed, studied and analyzed for decades. Exhaustive studies of aerodynamics over foil shapes have been conducted and reported. For example, research conducted by the National Advisory Committee for Aeronautics (NACA), now the National Aeronautics and Space Administration (NASA), compiled a NACA airfoil database of 1638 airfoils with various thickness and camber based on chord nodes.
(http ://airfoiltools.com/search/index?m%5BtextSearch%5D=&m%5BmaxCamber%5D=&m %5BminCamber%5D=&m%5BmaxThickness%5D=&m%5BminThickness%5D=&m%5Bgr p%5D=naca4d&m%5Bsort%5D=1&m%5Bpage%5D=2&m%5Bcount%5D=30)dk Many of the same principles apply to surfaces in the atmosphere such as wings, propellers, etc. or underwater such as rudders, propellers or boat hulls.
It is known that the chaotic flows over aerodynamic and hydrodynamic surface results in reduced performance and energy loss. Structural designs and physical enhancements of airfoils are commonly known and used to compensate for chaotic flow. They function to control and reduce energy loss. For example, the amount of lift an aircraft generates or pressure a spoiler induces, control at different operating speeds, performance, efficiency, stability and balance all change as the foil's shape is changed.
Many techniques for altering, modifying, controlling or otherwise manipulating fluid flow, whether in gas or liquid form, over fluid-influenced surfaces have been identified and implemented. For example, both the trailing edge and the leading edge of an aircraft wing may be straight or curved or one edge might be curved and the other straight. Or, one or both edges of an aircraft wing can be tapered so that it is narrower at the tip. The wing tip can be pointed, rounded, square or have structural extensions such as short, substantially vertical members attached to the aircraft wings at a significant distance from the plane's fuselage. They mitigate wing oscillation and movement caused by the air that flows around the wind during flight thereby stabilizing the wing and increasing performance and fuel efficiency under load. Other techniques include permanent or temporary coatings on the wings to prevent buildup of moisture or other substances on the surface.

The atmosphere is made up of gases that compress and of moisture that can be controlled by other than geometric shapes or attachments. The prior art has used complete hydrophilic or complete hydrophobic coatings to modify dynamics of foil shapes. However, hydrophobic coatings have properties which influence only certain dynamic influences. Similarly, hydrophilic coatings have properties which influence other dynamic influences.

These designs do not disclose the combined structure and function of the present invention. Accordingly, it would be an improvement in the art to provide improved coating systems to enhance control of aerodynamics and hydrodynamics over surfaces.

### SUMMARY OF THE INVENTION

The disclosed technology and present invention relate to novel patterns and pattern systems for enhanced control of flows of gaseous or liquid fluids over surfaces. The enhanced control is achieved by use of patterned features creating both hydrophilic and hydrophobic effects. The patterned features creating hydrophilic effects are positioned adjacent patterned features creating hydrophobic effects to achieve the desired flow dynamic effect or influence over the surface.
For example, patterned coatings may be applied to alter chaotic flow to create laminar and controlled flows over surfaces thereby resulting in enhanced aerodynamics and reducing loss caused by chaotic flow. This is useful for control of aerodynamics with minimal structural reconfiguration to wind turbines, aircraft bodies, ballistic bodies. These advantages are not limited to aerodynamics but can also be used also in bodies of water. Hydrodynamic control of chaotic flows using patterned hydrophobic and hydrophilic coatings also produce increased use of energy and stable flow.
Hydrophilic and hydrophobic effects can be created on surfaces at the nano and micron level with physical surface modifications such as laser ablation or etching resulting in nano and micron structures on surfaces. Such patterned nano and micron level modifications also provide physical effects providing enhanced flow dynamic controls. The manipulation of surface tension also provides means of stability along with the laminar flow and reduction in chaotic energy loss.
These and other features and advantages of the present invention will be set forth or will become more fully apparent in the description that follows and in the appended claims. The features and advantages may be realized and obtained by structure outlined methods and particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 depicts an illustrative view of one embodiment of the combined pattern of the present invention.

### DETAILED DESCRIPTION OF THE INVENTION

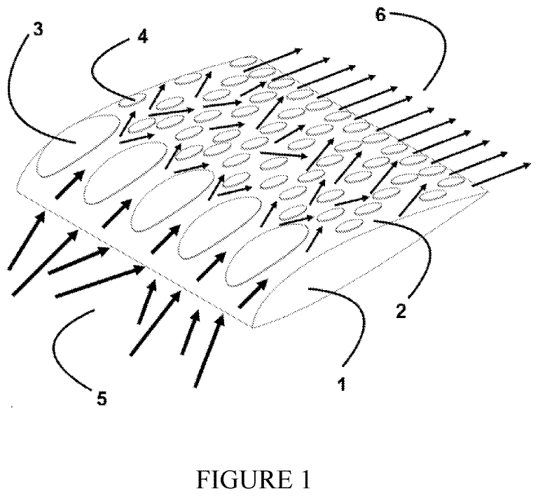

The disclosed technology and present invention relates to pattern features disposed on surfaces to enhance control of aerodynamic and/or hydrodynamic flow over surfaces. The enhanced control is derived from patterned features creating adjacent hydrophilic and hydrophobic effects. The patterned features creating hydrophilic effects are disposed adjacent patterned features creating hydrophobic effects to produce the desired flow dynamic effect or influence on or about the surface.
As shown in FIG. 1, airfoil 1 has a contour aerodynamic surface. Flow over contour surface 1 is depicted by arrow lines with flow in the direction of the arrows. Disposed upon surface 1 is a pattern feature(s) or area 2 creating hydrophilic effects such as increasing surface tension and/or absorbing energy to surface 1. Also disposed upon surface 1 are a plurality of pattern features 3 and 4 creating hydrophobic effects such as decreasing surface tension and deflecting energy to hydrophilic feature(s) 2 disposed between hydrophobic features 3 and 4. The size and shape of hydrophobic features 3 and 4 direct ambient pressures and increase velocities of flow over surface 1.
As illustrated in FIG. 1, chaotic flow 5 confronts a leading edge of surface 1. Selective, positional placement of hydrophobic features 3 and 4 induce laminar flow over surface 1 such that at the trailing edge of surface 1 laminar flow or substantial laminar flow 6 is achieved.
Where hydrophilic feature 2 will grab the atmosphere by changing surface tensions and hydrophobic features 3 and 4 will repel moisture and compressed gases, a pattern comprising both hydrophilic features 2 and hydrophobic features 3 and 4 can be applied to surface 1 depending on the desired aerodynamic effect.
Features 2, 3 and/or 4, and other features if desired, can be produced in a number of ways or combination of ways. For example, either hydrophilic or hydrophobic features can be disposed on surface 1 in a number of ways, including without limitation by means of masking, printing, ablating, etching, and/or abrasives applications or equivalents thereto. Disposition of features by masking can be in a single or double masking process. For example, surface 1 could first be masked to lay down features 3 and 4, followed by a negative masks for feature(s) 2, or vice-versa. In the alternative, feature 2 can be applied to the entirety of the desired extent of surface 1 followed by a mask to apply features 3 and 4. For example, a polymer host bearing a chosen hydrophilic substance or compound and a polymer host bearing a chosen hydrophobic substance of component are applied to surface 1 as features 2 and 3/4, respectively, consistent with the selected configuration provided by the masking process.
In the alternative, the desired features of substances and/or compounds may be disposed on surface 1 by printing each features in the desired pattern on surface 1. In the alternative, the desired features of substances and/or compounds may be printed on a film and the film being disposed upon surface 1.
In the alternative, the desired hydrophilic and/or hydrophobic effects in a selected pattern across surface 1 can achieved by altering surface 1 by physical ablation. Known techniques of physical ablation include, for example, abrasive removal, laser, sand blasting, electric discharge and/or plasma, and equivalent processes.
In the alternative, the desired hydrophilic and/or hydrophobic effects in a selected pattern across surface 1 can achieved by altering surface 1 by chemical etching.
These shapes of features 2, 3 and 4 can be any geometric shape calculated to achieve the desired hydrophilic or hydrophobic effect. For example, features 2, 3 and/4, and others if desired, may be curved in form as shown or FIG. 1. In the alternative, the features may include geometric shapes including hard or sharp angles, straight sides, dendrites or dendrites with no right angles and/or ameba-shaped to create the desired effects. In embodiments for cylinder-or spherical-shaped surfaces such as ballistics, bullets and the like, the feature shapes may comprise straight or curved lines or stripes along the about or along the length of the surface.
The selected substance or compound of each feature may comprise either micro- and nano-sized particles having hydrophilic or hydrophobic properties in any desired carrier known to those of skill in the art such as polymers, solgels, silica gels, siloxanes or other silicon-based products, and equivalents.
When applied in layered coatings, a hydrophilic layer may first be applied to surface 1 followed by a hydrophobic layer, or vice-versa depending on the desired dynamic effect across the surface.
While illustrated herein as to a contour airfoil surface, surface 1 may related to boat hulls for efficient forward motion, rotational stability at long distances for subsonic and supersonic ballistics, creating laminar flows before reaching propulsion blades, aerodynamics for downforce of high speed vehicles, e.g., formula cars, Lemans prototype cars, etc., reduction of chaotic flows from trailing or edge surfaces of air effects components, reduction of drag and chaotic energy loss to tractor trailers for efficiency and reduction of energy use in transporting goods, ceiling fans for better laminar air flow indoors, increase in energy efficiency for props for propulsion on boats and ships, increase in energy efficiency for propellers for propulsion on aircraft or turbines, increase in energy efficiency for props on drones, increase in energy efficiency for wind turbines or for smaller turbines due to more efficient use of wind, helicopter blades for control of energy loss and reduction of sound, coating of pipes internally to influence laminar flow on the surface reducing physical corrosion from fluid transportation (oil and gas) thereby reducing energy loss in pumping, bridge pillars for controlling chaotic flows and harmonic additive destructive energy due to wind forces, high-rise buildings control of air flows to reduce destructive stress forces due to wind, nozzles for water jets requiring laminar flow emissions, roof tiles to reduce wind damage in unstable atmospheric events (tornadoes, hurricanes, destructive high winds), radiator cooling system requiring laminar air flow to increase efficiency of heat transfer, and the like.
The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system for controlling flow over a surface, the system comprising:
one or more first features disposed on the surface, the one or more first features having hydrophilic properties;
one or more second features disposed on the surface, the one or more second features having hydrophobic properties; and
the one or more first features and the one or more second features arranged in a pattern such that hydrophilic features are disposed adjacent hydrophobic features on the surface.

2. The system of claim 1 wherein the one or more first features disposed on the surface or the one or more second features disposed on the surface comprise a geometric shape selected from the group of curved, hard-angled, sharp-angled, straight sides, dendrites, dendrites with no right angles, ameba-shapes, straight or curved line geometric configurations, or combinations thereof.

3. The system of claim 1 wherein the one or more first features disposed on the surface or the one or more second features disposed on the surface comprise micro- or nano-sized particles have corresponding hydrophilic or hydrophobic properties.

4. The system of claim 3 wherein the one or more first features disposed on the surface or the one or more second features disposed on the surface comprising micro- or nano-sized particles have corresponding hydrophilic or hydrophobic properties are hosted in a carrier selected from the group of polymers, solgels, silica gels, siloxanes or other silicone-based products.

5. The system of claim 1 wherein the one or more first features disposed on the surface are disposed in a layer and the one or more second features disposed on the surface are disposed in another layer.

6. A method for controlling flow over a surface, the method comprising the steps of:
disposing one or more first features on the surface, the one or more first features having hydrophilic properties;
disposing one or more second features on the surface, the one or more second features having hydrophobic properties; and
arranging the one or more first features and the one or more second features in a pattern such that hydrophilic features are disposed adjacent hydrophobic features on the surface.

7. The method of claim 6 wherein the one or more first features or the one or more second features are disposed on the surface using a masking process.

8. The method of claim 6 wherein the one or more first features or the one or more second features are disposed on the surface using a printing process.

9. The method of claim 6 wherein the one or more first features or the one or more second features are disposed on the surface using a physical ablation process.

10. The method of claim 9 wherein the physical ablation process is selected from the group of ablation removal, laser, sand blasting, electric discharge or plasma.

11. The method of claim 6 wherein the one or more first features or the one or more second features are disposed on the surface using a physical etching process.

12. The method of claim 6 wherein the one or more first features or the one or more second features are disposed on the surface using an abrasive application.

13. The method of claim 6 wherein the one or more first features or the one or more second features are disposed on the surface using a chemical etching process.

14. An apparatus comprising:
a contour surface;
one or more first features disposed on the contour surface, the one or more first features having hydrophilic properties;
one or more second features disposed on the contour surface, the one or more second features having hydrophobic properties; and
arranging the one or more first features and the one or more second features in a pattern such that hydrophilic features are disposed adjacent hydrophobic features on the surface.
hydrophobic features on the surface.

15. The apparatus of claim 14 wherein the one or more first features disposed on the surface or the one or more second features disposed on the surface comprise a geometric shape selected from the group of curved, hard-angled, sharp-angled, straight sides, dendrites, dendrites with no right angles, ameba-shapes, straight or curved line geometric configurations, or combinations thereof.

16. The apparatus of claim 14 wherein the one or more first features disposed on the surface or the one or more second features disposed on the surface comprise micro- or nano-sized particles have corresponding hydrophilic or hydrophobic properties.

17. The apparatus of claim 14 wherein the one or more first features disposed on the surface or the one or more second features disposed on the surface comprising micro- or nano-sized particles have corresponding hydrophilic or hydrophobic properties are hosted in a carrier selected from the group of polymers, solgels, silica gels, siloxanes or other silicone-based products.

18. The apparatus of claim 14 wherein the one or more first features disposed on the surface are disposed in a layer and the one or more second features disposed on the surface are disposed in another layer.
